(19) United States
(12) Patent Application Publication
(10) Pub. No.: US 2012/0202005 A1
(43) Pub. Date: Aug. 9, 2012

(54) Net Structure, in Particular for Geotechnical Applications

(75) Inventors: Pierluigi MAGGIONI, Barzano (Lecco) (IT); Cesare Beretta, Lomagna (Lecco) (IT)

(73) Assignee: TENAX S.P.A., Vigano (Lecco) (IT)

(21) Appl. No.: 13/365,335

(22) Filed: Feb. 3, 2012

(30) Foreign Application Priority Data
Feb. 3, 2011 (IT) MI2011A000149

(51) Int. Cl. B32B 5/12; B29C 65/00

(52) U.S. Cl. 428/114; 156/163

(57) ABSTRACT

A net structure for geotechnical applications includes a plurality of continuous ribs arranged parallel along an axis of development exhibit; at a first lie plane, a plurality of first continuous filaments, parallel and perpendicular to the ribs; and at a second lie plane, a plurality of second continuous filaments that are parallel to one another. The net structure is monolithic and defines an internal volume comprised between the first and the second lie planes sub-divided by the plurality of ribs into channels that are parallel to one another. The first filaments are defined by laminar structures exhibiting flat surfaces substantially lying in the lie plane, and a plurality of substantially rectangular windows are present at the first and second lie plane.

### CROSS-REFERENCE TO RELATED APPLICATION

This application claims the benefit of priority of Italian Patent Application No. MI2011A000149, filed Feb. 3, 2011, pursuant to 35 U.S.C. 119(a)-(d), the disclosure of which is incorporated herein by reference.

### TECHNICAL FIELD

The present description relates to a net structure in particular suitable for geotechnical applications.

The structure that is the object of the embodiment described herein below, made of plastic and monolithic material, is particularly suitable for drainage and in part also for containing the terrain on which it is used that, merely by way of example, can be constituted by road embankments, river banks, or even special sites such as tips or the like.

### BACKGROUND

As is known, the market offers numerous types of plastic net developed for enabling better drainage of the terrain and possibly a filtering and/or a containing of the terrain.

Among the various nets of known type, document U.S. Pat. No. 6,972,269 is cited, which illustrates a net structure for geotechnical applications comprising a first and a second layer of wire interconnected at nodes, by means of spacer elements destined to maintain the longitudinal and transversal wires of the net transversally distanced.

A coupling to a filtering element constituted by a textile is comprised at a lie plane of a series of the wires.

Also known, from document U.S. Patent Application Publication No. 2009/0075020, is a filtering and draining net for geotechnical applications which is constituted by a sandwich-type structure internally exhibiting a monolithic net structure exhibiting continuous longitudinal ribs to which respective nets are superiorly and inferiorly coupled, such that the corresponding cylindrical-section longitudinal wires couple exactly at the continuous longitudinal ribs.

In the lie planes defined by the links, filtering elements made of textile material are superiorly and inferiorly rigidly constrained (by gluing or welding), which each close the openings defined by the links with respect to the external environment in which the filter and drainage net is destined to work.

The textile structures exclusively enable percolation of liquids, such as, usually, water, so that the channels defined by the longitudinal ribs remain free and enable easier drainage.

Further, the dimensions of the links are selected such as to prevent collapses of the textile material which can lead to partial or total occlusion of the channels with a reduction in the drainage flow rate of the net.

A known document, GB 2252985, discloses a net structure made of plastic material obtained starting from a box configuration in which continuous longitudinal ribs are closed by two opposite sheets, appropriately perforated at respect longitudinal channels defined between the ribs.

The box structure can be stretched in one or the other of the longitudinal and transversal directions, or even in both directions.

### SUMMARY

Though the above-described prior art effectively performs its set tasks, it has however been seen to be liable to improvement in relation to certain aspects.

Firstly it has been noted that the product can be improved in its adaptation to the ground, its ability to receive and maintain an eventual filtering layer constrained thereto and its performance in terms of mechanical resistance, especially in a transversal direction to the continuous ribs.

It has also been noted that the desired structural characteristics can be obtained by adopting production procedures that are different to the ones commonly used for realising the above-cited nets, in any case obtaining optimal mechanical properties, reducing the weights per square metre of the net and improving the performance of the product in cost-effective terms.

Further, though endowed with considerable drainage capacity, the described product of the first prior art exhibits substantially no earth-containing properties, as it is exclusively able to facilitate a filtering and a draining of the liquids.

Further, from the point of view of production costs, and final costs of the product, it has been shown to be susceptible to improvement without sacrificing any of its peculiar features.

A general objective according to the aspects described in the following is such as to substantially resolve the operating drawbacks and/or limitations evidenced above.

A first aim according to some of the described aspects is to provide a net structure which is able not only to drain the liquids, but also to retain the earth, thus effectively also constituting a reinforcement.

A further aim, according to some of the described aspects, is to lower production costs and simplify eventual elimination operations of the product.

A further aim, according some of the described aspects is to increase the mechanical characteristics of the structure by contemporarily reducing the weight thereof per surface unit.

These and other aims which will better emerge during the course of the following description are substantially attained by a net structure according to one or more of the appended claims.

A first independent aspect relates to a net structure, in particular for geotechnical applications, comprising: a plurality of continuous ribs arranged substantially parallel along a first development axis; a plurality of first continuous filaments arranged substantially parallel to one another and transversally of the plurality of ribs, the first filaments being constrained to the ribs at nodes lying in a first lie plane; a plurality of second continuous filaments arranged substantially parallel to one another and transversally of the plurality of ribs, the second continuous filaments being constrained to the ribs at nodes lying in a second lie plane, the second lie plane being opposite the first lie plane with respect to the ribs; the plurality of first and second filaments defining an internal volume of the net structure comprised between the first and the second lie plane, the internal volume being subdivided by the plurality of ribs into a predetermined number of substantially parallel channels, characterised in that at least the first filaments and/or the second filaments are defined by laminar structures exhibiting respective surfaces which are flat and which lie substantially in the respective lie plane.

A further independent aspect relates to a net structure, in particular for geotechnical applications, comprising a plurality of continuous ribs arranged substantially parallel along a first development axis; a plurality of first continuous filaments arranged substantially parallel to one another and transversally of the plurality of ribs; the first filaments are constrained to the ribs at nodes lying in a first lie plane; a plurality of second continuous filaments arranged substantially parallel to one another and transversally to the plurality of ribs; the second continuous filaments are constrained to the ribs at nodes lying in a second lie plane; the second lie plane is opposite the first lie plane with respect to the ribs; the plurality of first and second filaments define an internal volume of the net structure comprised between the first and the second lie plane; the internal volume is subdivided by the plurality of ribs into a predetermined number of substantially parallel channels and the first filaments and the ribs define in the first lie plane a series of windows having a substantially polygonal shape configured such as to enable, in use conditions of the net structure, passage of solid material towards the internal volume and in that the second filaments and the ribs define in the second lie plane a series of windows having a substantially polygonal shape configured such as to enable, in use conditions of the net structure, passage of solid material towards the internal volume.

In a further aspect according to any one of the preceding aspects, the plurality of first filaments and/or the plurality of second filaments exhibit, in a perpendicular view to the respective lie plane, a width having a decreasing progression starting from a node up to a halfway line and an increasing progression from the halfway line up to the next node.

In a further aspect according to any one of the preceding aspects the plurality of ribs and/or the first filaments and/or the second filaments are made of a plastic material, for example based on polypropylene, and microscopically exhibit fibrous structures defining configurations of the molecules of the plastic material which are at least partially orientated.

In a further aspect according to any one of the preceding aspects the second filaments are defined by laminar structures and exhibit flat surfaces, substantially lying in the respective lie plane.

In a further aspect according to any one of the preceding aspects the first filaments and the ribs define, in the first lie plane, a series of windows having a substantially polygonal shape configured such as to allow, in use conditions of the net structure, passage of solid material towards the internal volume and wherein the second filaments and the ribs define, in the second lie plane, a series of windows having a substantially polygonal shape configured such as to allow, in use conditions of the net structure, passage of solid material towards the internal volume.

In a further aspect according to any one of the preceding aspects, the net structure does not comprise filter elements, especially in a form of layers of textile or non-woven textile, covering the substantially polygonal-shaped windows of the first and/or the second lie plane.

In a further aspect according to any one of the preceding aspects, the windows of the first and/or the second lie plane remain open and accessible to the solid material, especially comprising detritus, stones and/or earth, when the net structure is in use in a finished product form.

In a further aspect according to any one of the preceding aspects, the substantially polygonal windows in the first lie plane are positioned offset, in particular translated with respect to the first development axis, with respect to the substantially polygonal windows positioned in the second lie plane.

In a further aspect according to any one of the preceding aspects, the plurality of continuous ribs exhibit, in a perpendicular view to the lie plane thereof, a height at the nodes which is greater than the height of the zone comprised between a node and a next.

In a further aspect according to any one of the preceding aspects, each node, in a perpendicular view to the lie plane of the first and the second plurality of filaments, exhibits a substantially flat trapeze-shaped configuration, with concave sides constituted by arched portions.

In a further aspect according to any one of the preceding aspects, the continuous ribs extend substantially from the first lie plane to the second lie plane substantially along the whole longitudinal development thereof along the development axis.

In a further independent aspect, or an aspect according to any one of the preceding aspects, a method is comprised for realising a net structure which comprises steps of: coextruding a plurality of continuous ribs arranged substantially parallel along a first development axis and a plurality of first and second continuous filaments arranged substantially parallel to one another, transversal to the plurality of ribs and lying respectively in a first lie plane and a second lie plane opposite the first lie plane with respect to the ribs such as to create an internal volume of the net structure comprised between the first and the second lie plane and such as to define a semifinished three-dimensional net, the internal volume being subdivided by the plurality of ribs in a predetermined number of substantially parallel channels; performing a stretching operation on at least the first and/or the second filaments along the respective development axis; optionally performing a stretching operation of the ribs along the respective development axis.

In a further aspect according to the preceding aspect the method comprises a step of not constraining filtering elements at the substantially polygonal profiled windows in the first and the second lie plane.

In a further independent aspect, or an aspect according to any one of the preceding aspects, use is comprised of a net structure in geotechnical applications, comprising positioning the structure in a site to be conditioned and at least partially filling the channels with the material constituting the site.

In a further aspect according to the preceding independent aspect the method comprises the step of unremovably coupling at least a substantially flat first filtering element located at one of the lie planes, substantially in an external position to the internal volume of the net structure, in particular the coupling step following the stretching step of the first and/or second filaments along the respective development axis, the first filtering element being unremovably constrained to the nodes and/or the first and/or second filaments.

In a further aspect according to the preceding aspect the method comprises the step of unremovably coupling at least a substantially flat second filtering element located at one of the lie planes, substantially in an external position to the internal volume of the net structure, the second filtering element being unremovably constrained to the nodes and/or the first and/or second filaments.

In a further aspect according to any one of the preceding aspects, a method is comprised for realising a net structure comprising steps of coextruding the continuous ribs, the first and second filaments for defining a net semi-finished workpiece; performing a stretching operation at least of the ribs and/or the first and/or the second filaments along the respective development axis; not constraining filtering elements at the substantially polygonal profiled windows.

Further characteristics and advantages will emerge in greater detail in a description of a preferred but not exclusive embodiment of a net structure according to the accompanying tables of drawings.

### BRIEF DESCRIPTION OF THE DRAWINGS

Some embodiments and some aspects of the invention will be described herein below with reference to the accompanying drawings, purely by way of non-limiting example, in which:

FIG. 1 illustrates a perspective view partially from above of a net structure according to some aspects described in the following;

FIG. 2 is the net structure in a view from above;

FIG. 3 shows the net structure in a lateral perspective view;

FIG. 4 is a view from above of a pair of nodes of the net structure of FIG. 1;

FIG. 5 is a lateral view of a portion of the net structure of FIG. 1;

FIGS. 6 and 7 illustrate an embodiment of the micromolecular structure of the material constituting the net structure according to the prior art (FIG. 6) and according to some aspects of the embodiment described in the following (FIG. 7);

FIG. 8 is a first variant of the net of FIG. 1;

FIG. 9 is a transversal section of the new of FIG. 8;

FIG. 10 is a further embodiment of the net of FIG. 1;

FIG. 11 is a transversal section of the net of FIG. 10;

FIG. 12 is a perspective view of a semi-finished workpiece suitable for obtaining the net of FIG. 1;

FIG. 13 is a view from above of the semi-finished workpiece of FIG. 12; and

FIG. 14 is a section along axis XIV-XIV of the semi-finished workpiece of FIG. 12.

### DETAILED DESCRIPTION

With reference to the figures of the drawings, 1 denotes in its entirety a net structure, particularly for geotechnical applications.

Looking at the attached figures, it can initially be seen that the net structure comprises a plurality of substantially parallel continuous ribs 2 arranged along a first axis of development 3.

Also present are a plurality of first substantially continuous filaments 4 arranged parallel to one another and transversal to the plurality of ribs 2 to which they are constrained at respective nodes 5.

As can be seen from the accompanying figures, the plurality of first continuous filaments is arranged with their axis 17 substantially perpendicular to the first axis of development 3; each first continuous filament 4 is arranged in a same lie plane 6 which is positioned at an upper surface of the plurality of continuous ribs 2.

Correspondingly, and on the opposite side with respect to the first lie plane 6 with respect to the ribs 2, a plurality of second substantially continuous filaments 7 are present, also arranged parallel to one another and transversal to the ribs 2.

In detail the second filaments 7 are also constrained to the ribs at the respective nodes 5 and all lie in a same second lie plane 8.

In fact the two lie lines are parallel to one another and spaced exactly for the height of the above-mentioned plurality of continuous ribs 2.

In particular, the continuous ribs 2 exhibit a height that is substantially similar/comparable to the distance between the two lie planes 6, 8.

In fact, the plurality of first and second filaments 4, 7, define an internal volume of the net structure 1, which is comprised between the first and second lie plane 6, 8.

This internal volume is divided in turn into a predetermined number of 10 channels each defined by two respective flanked continuous ribs 2.

The ribs 2 define continuous lateral walls 10 delimiting the channels 10. In particular the walls extend substantially along the entire length of the rib 2—along the axis of development 17—and also extend over substantially the entire height between a lie plane 6 and another 8.

The network structure is constituted by plastic material, in particular polypropylene.

In addition, the net structure is a monolithic element constituted by the above-mentioned continuous ribs 2, the first continuous filaments 4 and the second continuous filaments 7.

Observing the net structure at the first lie plane of the first lie plane 6, the first filaments 4 and the ribs 2 can be seen to define a series of substantially polygonal windows 11.

In detail, with regard to the perpendicular geometry of the respective axes, the windows 11 are substantially rectangular or square; in the illustrated example the relation between two sides of the rectangular shape is about 1:1.1

Note also that the windows will all be of the same shape or different shapes when the first continuous filaments 4 and/or the continuous ribs 2 are not equally spaced as shown in the attached drawings.

In fact the particular illustrated embodiment shows a plurality of equally spaced continuous ribs 2 between them, as well as a first plurality of continuous filaments 4, also equally spaced and a plurality of continuous second filaments 7 equally spaced from each other by a distance equal to that between two continuous adjacent filaments 4 of the first series.

In this way the windows 11 defined on the first lie plane 6 and on the second lie plane 8 have substantially the same surface and geometry.

Note that at this point, advantageously, each of the windows 11 is generally speaking of dimensions such as to allow the passage of solid material into the internal volume 9 and thus successive application of a filter element (as better clarified in the following) serves to enable passage of the liquids towards the inside of the net but prevents passage of debris internally of the channels that might otherwise become obstructed.

Observing the net structure in greater detail, the polygonal windows 11 located on the first lie plane 6 are in an offset position, and in detail are translated along the first axis of development 3 with respect to the windows 11 located in the second lie plane 8.

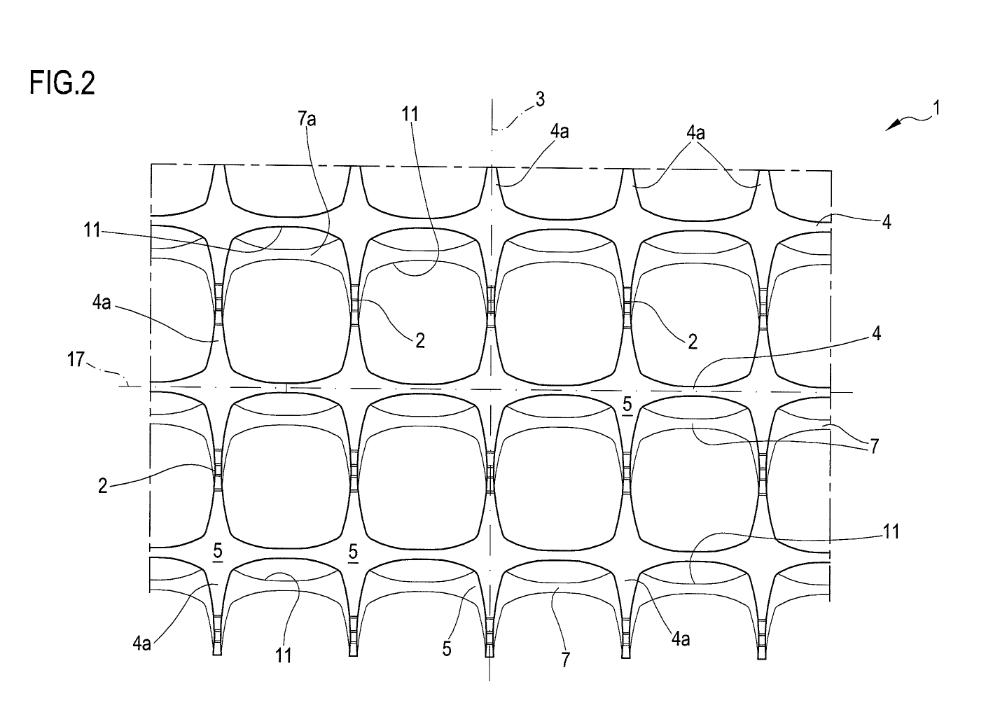

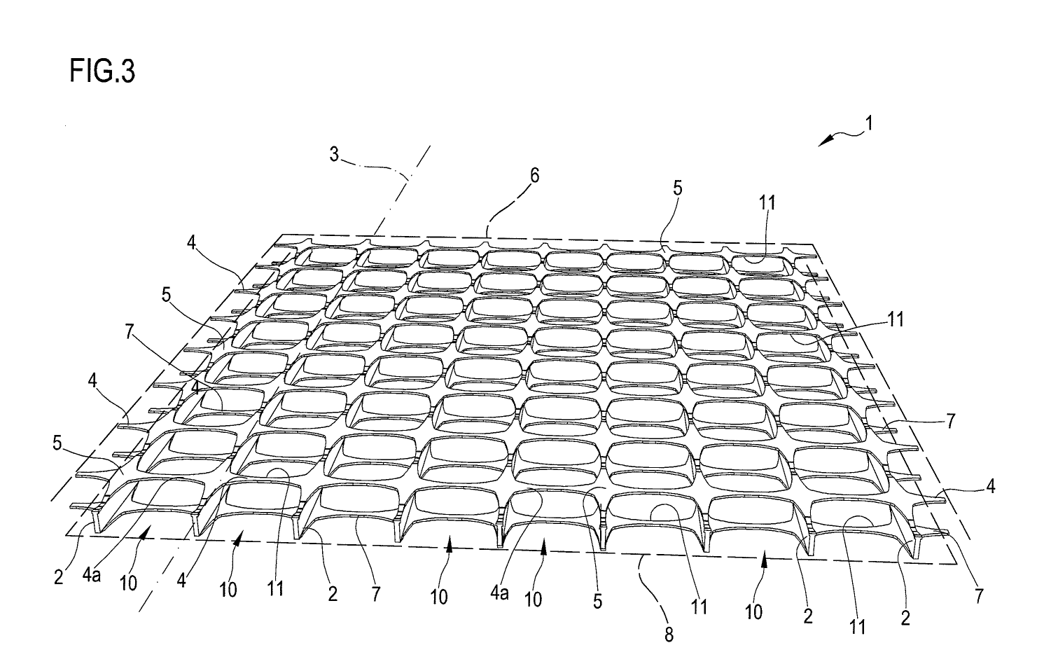

This means that in a perpendicular view to each of the lie planes, both the first and the second filaments 4, 7 are visible (see FIG. 2).

Looking in detail at the net structure, in a perpendicular view to the respective lie plane the first plurality of filaments 4 and the second plurality of filaments 7 exhibit a width L that has a decreasing-increasing progression as it goes from one node 5 to the next node 5.

In particular, the width L starts from a maximum at the node and then decreases in a non-linear but progressive fashion up to the halfway line 12, and then performs substantially an inverse, i.e. increasing progression, non-linearly up to the next node.

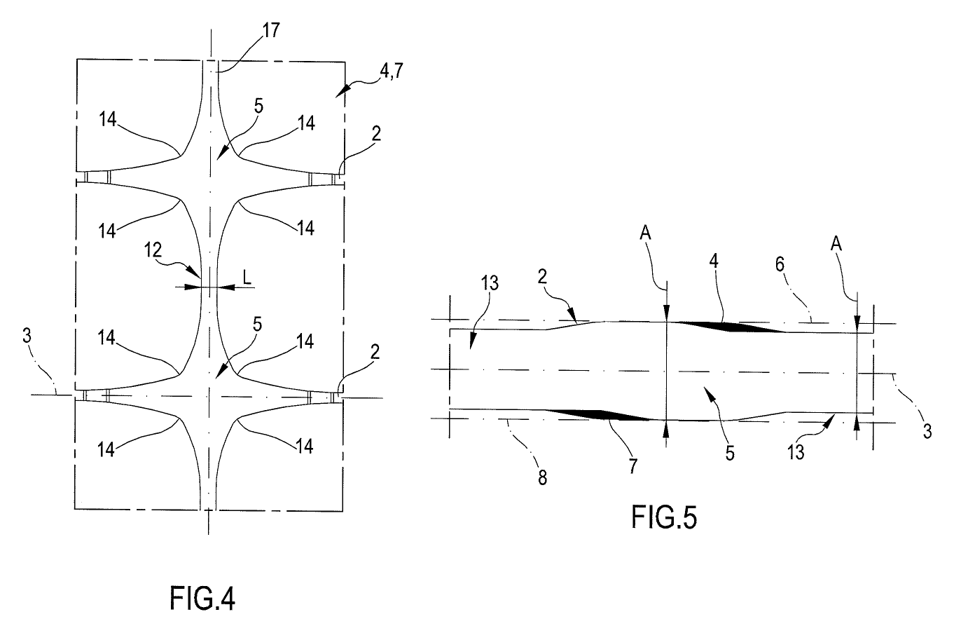

See FIG. 4 for an illustration of this.

As also seen in the accompanying figures the first filaments 4 and/or the second filaments 7 are defined by structures exhibiting flat surfaces 4a, 7a lying in the lie planes 6, 8.

In other words, the first and second filaments 4, 7 are in the form of strips (in particular their section recalls a rectangular cross section) which are thin and have smaller dimensions than the transversal development (as defined in the direction of the axis 17) and the longitudinal development (defined in the direction of the axis 3); this substantially flat configuration makes the filaments more likely to cooperate with and engage to the filter element to be applied to the net.

Note of course that the progression is a mean progression and should not be interpreted in the strict geometric sense because, as will be clarified herein below, the structure is obtained through the operations of extrusion/coextrusion and stretching of the plastic material and therefore there will be certain irregularities present in the overall structure arising inherently from the manufacturing process used.

The extension of the continuous ribs is different according to the point at which the rib itself is observed along the axis of development 3.

In particular, in a perpendicular view from the plane of development thereof, the continuous ribs 2 have a height A at the nodes 5 which is greater than the height in the zone 13 comprised between a node and a next node.

This progression is evidenced in FIG. 5.

Returning to observe FIG. 4, each node 5, in a view perpendicular to its lie plane, has a substantially flat trapezoidal configuration with concave sides constituted by arched portions 14 or in any case curved portions.

As mentioned this area of the node is substantially flat and in fact increases the surface at each of the lie planes so as to better distribute the compressive stresses on the net structure.

From the point of view of production, the net structure is co-extruded in a single operation by contemporaneously realising the longitudinal ribs 2, the first continuous filaments 4 and the second continuous filaments 7.

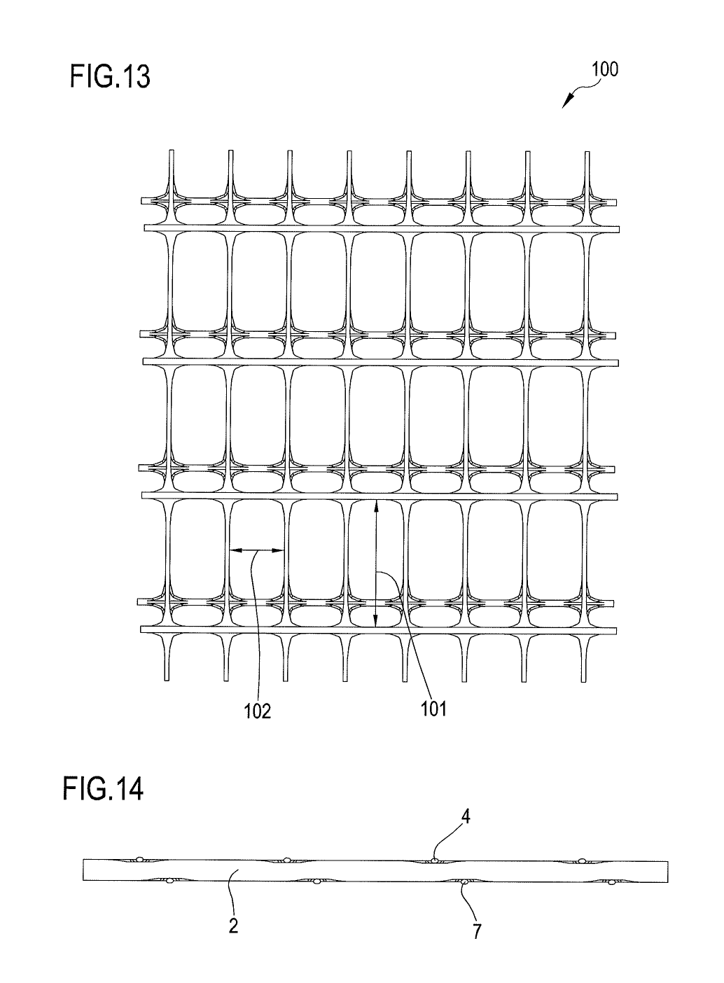

In detail, a sub-step of extrusion of the longitudinal ribs 2 occurs, on which the tow orders of filaments 4, 7 are applied before solidification, at the respective lie planes 6, 8. In this step, the filaments 4, 7 have a certainly irregular section due to the plasticity of the material but which tends to assume, generally speaking, a circular section (see FIG. 14).

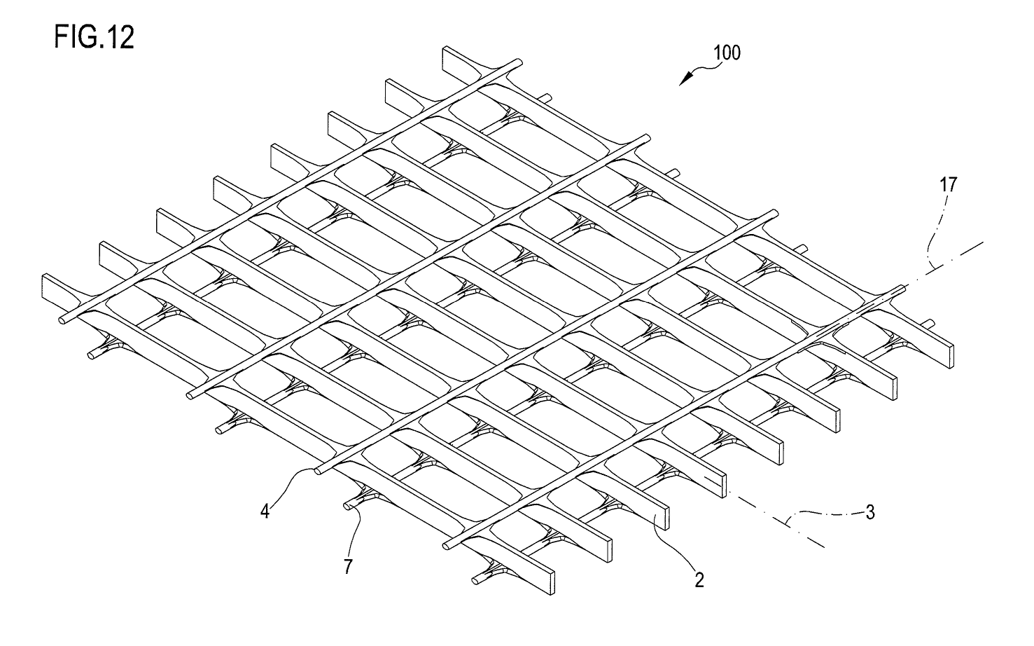

The semi-finished workpiece 100, thus obtained, is shown in FIG. 12 in a perspective view and in FIG. 13 in a plan view.

As can be seen from the last figure, there are elongate rectangular windows in which the ratio between the longitudinal dimensions 101 and the transversal dimensions 102 is comprised between 6:1 and 1.5:1, for example is comprised between 4:1 and 2:1 and in general is about 3:1.

Prior to complete solidification thereof the net is then stretched in at least one of the axes of development axes 3, 17.

In other words, the net is extended by stretching at least one of the ribs and/or the first and/or the second filaments.

In general, the configuration used is that of a net that enables increasing the mechanical strength characteristics against stress forces, while also reducing the weight per unit area.

In detail, the draw ratio in the extrusion direction (MD) of the production machine is between 1 and 4, more particularly between 1.1 and 2 and will by way of example be around 1.2; the direction MD coincides with the development direction of the longitudinal ribs (axis of development 3).

The draw ratio in the transversal direction (TD) to the extrusion direction of the production machine is between 1 and 7, more particularly between 2 and 5 and will be by way of example be about 3.5; the direction TD coincides with the development direction of the axis of the transversal filaments (axis of development 17).

The step of stretching the filaments brings them to modify the configuration thereof in section from circular to flat, with the flat surfaces lying in the respective lie planes.

The overall thickness of the transversal filaments and the ribs is comprised between 4 and 6.8 mm; in more detail it is within the range of 4.5 to 6.3 mm and is centred at about 5.4 mm.

Note that after the stretching step the first and the second continuous filaments 4, 7 define, in the respective lie planes, a series of substantially rectangular windows (almost square in the illustrated example) with a ratio between the long side and the short side comprised between 6:1 and 1:1, in particular comprised between 4:1 and 1:1 and about 1.1:1.

It should be noted also that the stretching operation described above has an effect at the level of the molecular structure of the plastic, such that for each of the stretched ribs and/or the stretched filaments, fibrous structures 15 are created defining at least partially orientated configurations 16 of the molecules of the plastic material.

This configuration is illustrated in FIG. 7.

Through stretching, i.e. a cutting action, structures are thus generated following a molecular positioning; these structures facilitate considerable increases in mechanical resistance and rigidity in the desired direction and the superstructures are indicated as fibrous structures.

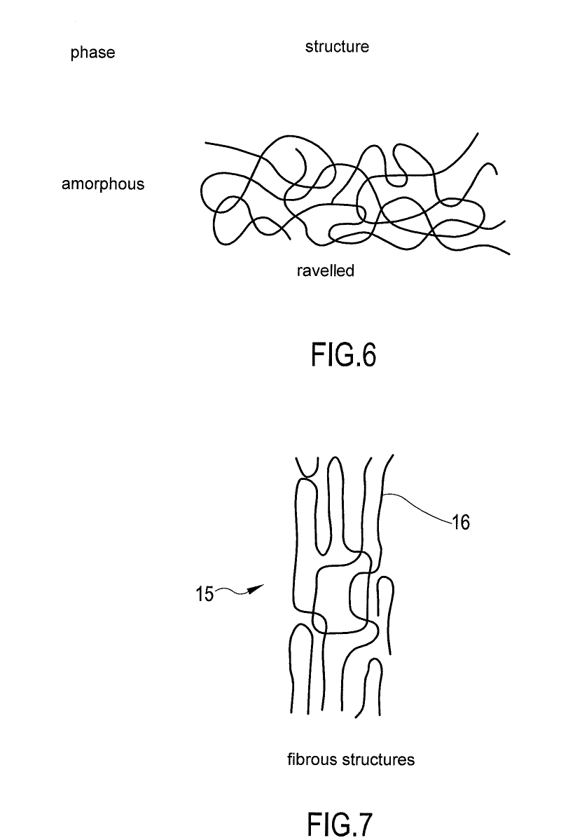

In still other words, the material passes from an amorphous phase with a structure that can be defined as raveled (see FIG. 6) and a structure that is at least partially oriented.

This molecular orientation with parallel arrangement of the molecules generates a corresponding anisotropy of the properties of the material, producing, in the orientation direction, an increase in rigidity.

Further, the stretching operation of the first and second filaments 4, 7 along the respective development axis 3 and/or the stretching operation of the ribs 2 along the respective development axis 17 is performed up to defining at most a ratio between the height of the ribs (understood as the distance between the two lie planes 6, 8) and the distance between two ribs 2 which run adjacently that is less that 1:7 and in particular the ratio is in any case greater than 1:2.

A ratio of greater than 1:7 would lead to the collapse of the mesh under the effect of the weight of the terrain, obstructing the channels between two flanked ribs and causing the structure to lose effectiveness in terms of drainage.

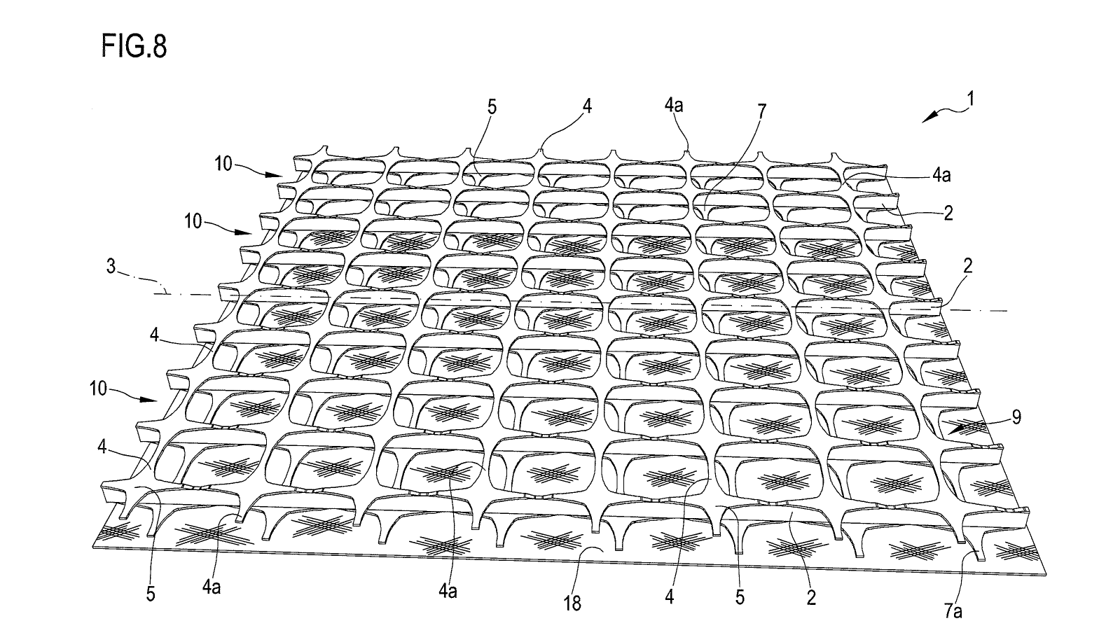

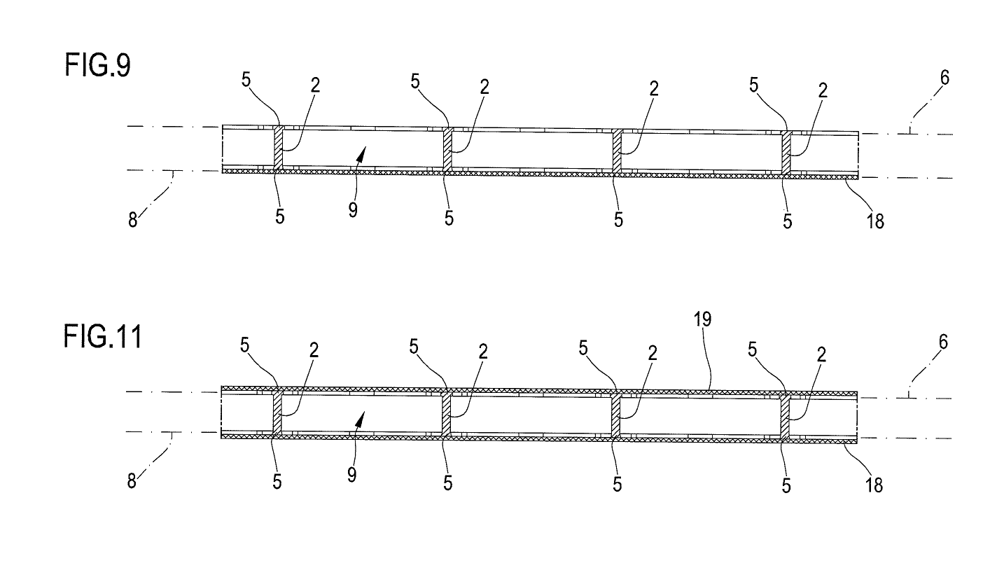

The embodiment of FIGS. 8 and 9 shows a net structure with a first filter element 18 coupled, in particular unremovably (welded, glued or otherwise), to the first or second filaments 4, 7.

In general, the coupling is direct, i.e. without interposition of other layers or elements between the filaments 4, 7 and the first filter element 18. The flat surface 4a, 7a facilitates the coupling thanks to the greater contact surface, which contributes to the solidity of the engagement between the parts.

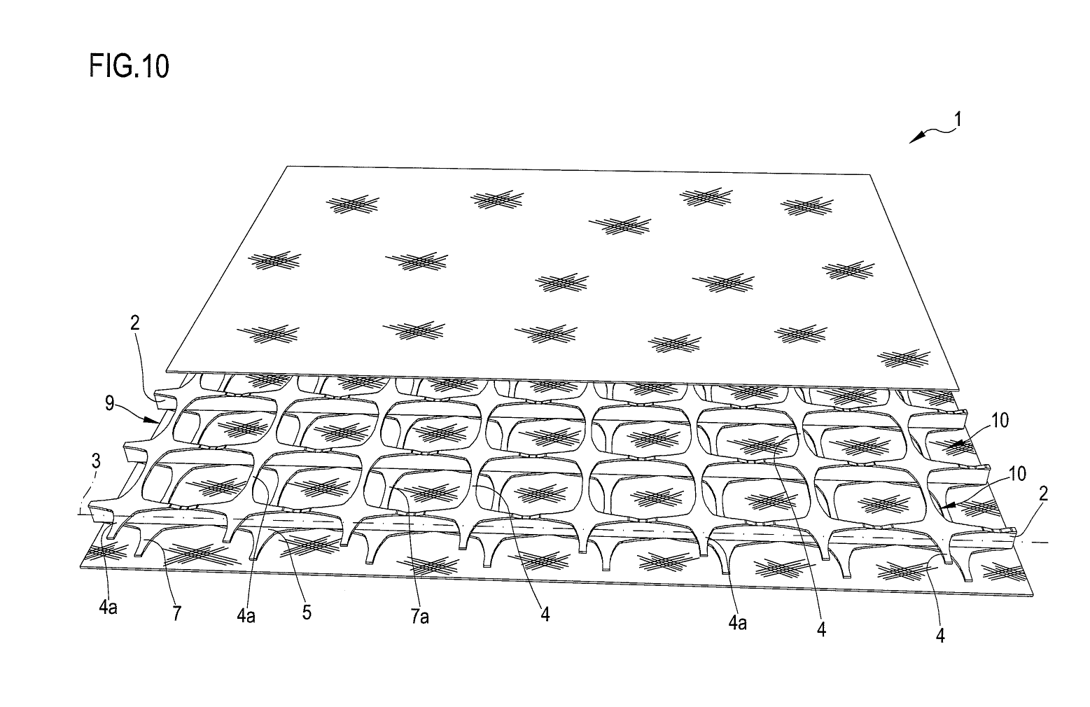

The example of FIGS. 10 and 11 shows a reticular structure that exhibits two filter elements 18, 19 coupled at the two opposite lie planes 18, 19 in the same manner as described above.

This further type of structure defines channels 10 in which, under use conditions, only a liquid (water) and eventually any dust can enter, while any solid material larger than those of the cavity that pass through the filter element 18, 19 is confined to the outside, thus allowing the correct and maximum flow of the water in the channels, substantially free of debris.

Note that all the technical features described with reference to the first embodiment are also present in the second and third embodiment described above.

The net structure is generally used in geotechnical applications, with an appropriate net area yardage for a site to be addressed.

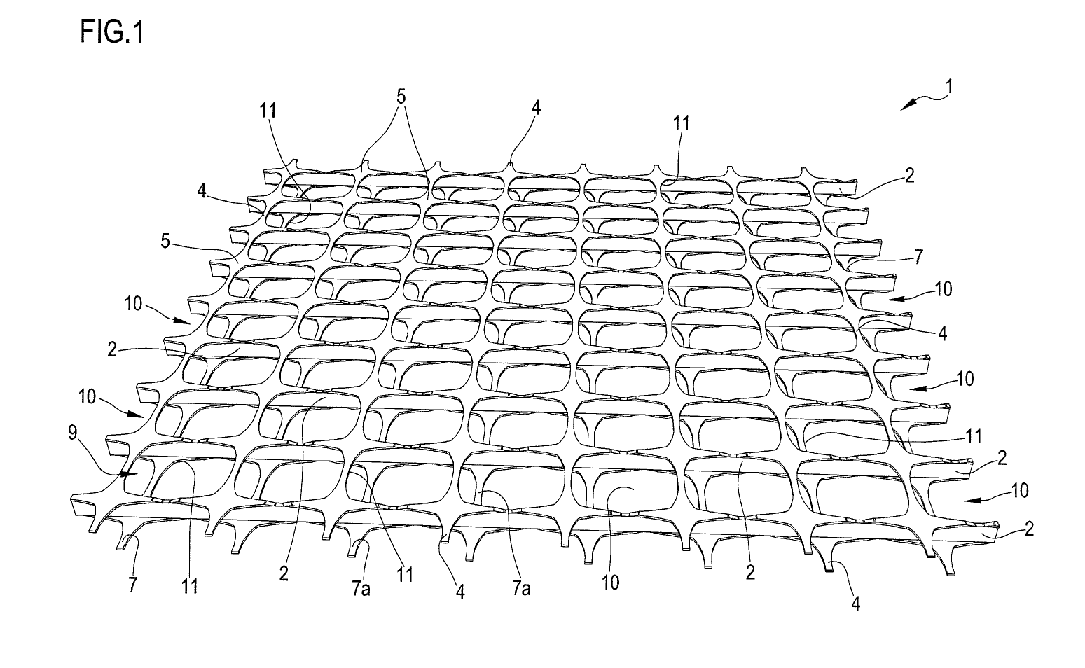

Since there might be no closure elements of the windows, as in the example shown in FIG. 1, the material constituting the site where the structure is placed tends to fill the channels 10.

Despite this filling phenomenon, the structure retains a good filtering capacity as the continuous longitudinal ribs direct the flow of liquids according to the orientation of the network.

Furthermore, the ribs (with the cooperation of the structures defined by the flat transversal filaments) retain the terrain, thus exerting a mechanical containing pressure.

Surprisingly therefore, the presence of solid material within the channels does not completely obstruct the outflow of the liquid which continues to be directed, but ensures an optimal coupling with the net structure and the terrain and maintains it in position.

Disposal is also facilitated because the product is made from a single and same material.

In addition, the increased upper and lower surface (guaranteed by the flat geometry of the first and second filaments and nodes) greatly improves the load distribution.

In this situation the three-dimensional net product lends itself well to a perfect coupling with any filter elements present, providing an improved engagement to one another (FIGS. 8 and 10).

The net structure is, weight for weight, considerably more rigid, so the size of the channels and/or the windows can be varied while ensuring that the integrity of the structure is maintained.

The structure of the object of the description is particularly advantageously applicable in various sites among which is presented by way of example and therefore not limited to road embankments, banks, and areas used as landfill.

It will be apparent to those skilled in the art that various modifications and variations can be made to the net structure of the present disclosure without departing from the scope of the invention. Throughout the disclosure, use of the terms “a,” “an,” and “the” may include one or more of the elements to which they refer. Other embodiments of the invention will be apparent to those skilled in the art from consideration of the specification and practice of the invention disclosed herein. It is intended that the specification and examples be considered as exemplary only.

What is claimed is:

1. A method of realising a net structure for geotechnical applications, the net structure having:
a plurality of continuous ribs arranged substantially parallel along a first development axis;
a plurality of first continuous filaments arranged substantially parallel to one another and transversally of the plurality of ribs, the first filaments being constrained to the ribs at nodes lying in a first lie plane; and
a plurality of second continuous filaments arranged substantially parallel to one another and transversally of the plurality of ribs, the second continuous filaments being constrained to the ribs at nodes lying in a second lie plane, the first filaments and the second filaments being defined by laminar structures exhibiting respective surfaces which are flat and which lie substantially in the respective lie plane, the second lie plane being opposite the first lie plane with respect to the ribs, the plurality of first and second filaments defining an internal volume of the net structure comprised between the first and the second lie plane, the internal volume being subdivided by the plurality of ribs into a predetermined number of channels that are substantially parallel;
the method comprising steps of:
coextruding a plurality of continuous ribs arranged substantially parallel along a first development axis and a plurality of first and second continuous filaments arranged substantially parallel to one another, transversely to the plurality of ribs and lying respectively in a first lie plane and a second lie plane opposite the first lie plane with respect to the ribs to create an internal volume of the net structure comprised between the first and the second lie plane and to define a semi-finished three-dimensional net, the first and second continuous filaments defining, in the respective lie planes, a series of substantially polygonal windows, the internal volume being subdivided by the plurality of ribs into a predetermined number of substantially parallel channels; and
performing a stretching operation on the first and the second filaments along the respective development axis in order for the respective surfaces thereof to take on a flat configuration substantially lying in the respective lie plane.

2. The method of claim 1, comprising a step of performing a stretching operation of the ribs along the respective development axis.

3. The method of claim 1, comprising a step of unremovably coupling at least a substantially flat first filter element located at one of the lie planes substantially in an external position to the internal volume of the net structure, the step of coupling being successive to the step of stretching the first and second filaments along the respective development axis, the first filter element being unremovably constrained at least to the nodes or to the first or second filaments.

4. The method of claim 3, comprising a step of unremovably coupling a second substantially flat filter element located at the other of the lie planes substantially in an external position to the internal volume of the net structure, the second filter element being unremovably constrained at least to the nodes or to the first or second filaments.

5. The method of claim 1, comprising performing a stretching operation on the first and the second filaments along the respective development axis up to defining at most a ratio between the height of the ribs, taken as a distance between two lie planes and a distance between two ribs running adjacent, of less than 1:7.

6. The method of claim 1, wherein the step of stretching the first and second filaments along the respective development axis is performed with a stretching ratio comprised between 1:1.1 and 1:7.

7. The method of claim 1, wherein the step of stretching the ribs along the respective development axis is performed with a stretching ratio comprised between 1:1.1 and 1:3.

8. The method of claim 1, wherein the step of co-extruding a plurality of continuous ribs and a plurality of first and second continuous filaments comprises a sub-step of extruding the plurality of continuous ribs arranged substantially parallel along the first development axis and a sub-step of applying, on the already-extruded ribs at the first lie plane of the plurality, first continuous filaments in the form of filaments of irregular and substantially circular section and a sub-step of application on the already-extruded ribs at the second lie plane of the plurality of second continuous filaments in a form of filaments having irregular and substantially circular section.

9. The method of claim 1, wherein the first and second continuous filaments define, in the respective lie planes of the semi-finished three-dimensional net, a series of substantially elongate rectangular windows with a ratio between the long side and the short side comprised between 6:1 and 1.5:1, the first and the second continuous filaments defining, in the respective lie planes after the steps of stretching, a series of substantially rectangular windows with a ratio between a long side and a short side thereof being comprised between 6:1 and 1:1.

10. A net structure for geotechnical applications, comprising:
a plurality of continuous ribs arranged substantially parallel along a first development axis;
a plurality of first continuous filaments arranged substantially parallel to one another and transversally of the plurality of ribs, the first filaments being constrained to the ribs at nodes lying in a first lie plane; and
a plurality of second continuous filaments arranged substantially parallel to one another and transversely of the plurality of ribs, the second continuous filaments being constrained to the ribs at nodes lying in a second lie plane, the second lie plane being opposite the first lie plane with respect to the ribs, the plurality of first and second filaments defining an internal volume of the net structure comprised between the first and the second lie plane, the internal volume being sub-divided by the plurality of ribs into a predetermined number of channels that are substantially parallel, at least the first filaments and the second filaments being defined by laminar structures exhibiting respective flat surfaces that substantially lie in the respective lie plane.

11. The structure of claim 10, wherein the plurality of first filaments and the plurality of second filaments exhibit, in a perpendicular view to the respective lie plane, a width having a decreasing progression starting from a node up to a halfway line and an increasing progression from the halfway line up to the next node.

12. The structure of claim 10, wherein the plurality of ribs and the first filaments and the second filaments are made of a plastic material and microscopically exhibit fibrous structures defining configurations of the molecules of the plastic material which are at least partially orientated.

13. The structure of claim 10, further comprising at least a substantially flat first filter element located at one of the lie planes substantially in an external position to the internal volume of the net structure, the first filter element being unremovably constrained at least to the nodes or to the first or second filaments.

14. The structure of claim 10, further comprising a substantially flat second filter element located at the other of the lie planes substantially in an external position to the internal volume of the net structure, the second filter element being unremovably constrained at least to the nodes or to the first or second filaments.

15. The structure of claim 10, wherein substantially polygonal windows in the first lie plane are positioned offset with respect to substantially polygonal windows positioned in the second lie plane.

16. The structure of claim 10, wherein the plurality of continuous ribs exhibit, in a perpendicular view to the lie plane thereof, a height at the nodes which is greater than the height of the zone comprised between a node and a next, the continuous ribs extending substantially from the first lie plane to the second lie plane substantially along a whole longitudinal development thereof along the development axis.

17. The structure of claim 10, wherein each node, in a perpendicular view to the lie plane of the first and the second plurality of filaments, exhibits a substantially flat trapeze-shaped configuration, with concave sides constituted by arched portions.

18. The structure of claim 10, wherein the first and second continuous filaments define, in the respective lie planes, a series of substantially rectangular windows with ratios between the long side and the short side comprised between 6:1 and 1:1.
